(19) United States
(12) Patent Application Publication
(10) Pub. No.: US 2017/0294051 A1
(43) Pub. Date: Oct. 12, 2017

(54) SYSTEM AND METHOD FOR AUTOMATED VISUAL CONTENT CREATION

(71) Applicant: PCMS Holdings, Inc., Wilmington, DE (US)

(72) Inventor: Tatu V. J. Harviainen, Helsinki (FI)

(73) Assignee: PCMS Holdings, Inc., Wilmington, DC (US)

(21) Appl. No.: 15/512,016

(22) PCT Filed: Sep. 9, 2015
(86) PCT No.: PCT/US2015/049189

§ 371 Date: Mar. 16, 2017

Related U.S. Application Data
(60) Provisional application No. 62/055,357, filed on Sep. 25, 2014.

(51) Int. Cl. G06T 19/00; G06T 13/20

(52) U.S. Cl. CPC G06T 19/006; G06T 13/205

(57) ABSTRACT

Systems and methods are described for automated generation of augmented reality (AR) content. An exemplary method includes receiving video data from an image sensor of an AR device, identifying a two-dimensional (2-D) geometric feature depicted in the received video data, and generating a virtual three-dimensional (3-D) geometric element by extrapolating the 2-D geometric feature into three dimensions. The method also includes modulating the generated virtual geometric element in synchrony with an audio input and displaying the modulated virtual geometric element on a video output of the AR device. The method may be executed in real-time.

### CLAIM OF PRIORITY AND RELATED APPLICATIONS

The present application is a non-provisional filing of, and claims benefit under 35 U.S.C. §119(e) from, U.S. Provisional Application No. 62/055,357 filed on Sep. 25, 2014, the contents of which are incorporated by reference herein.

### BACKGROUND

Augmented Reality (AR) aims at adding virtual elements to a user's physical environment. AR holds a promise to enhance our perception of the real world with virtual elements augmented on top of physical locations and points of interest. One of the most common use cases presented in numerous AR applications is simple visualization of virtual objects by means of three-dimensional (3-D) computer generated graphics. Often the content production required to manufacture meaningful virtual content for AR applications turns out to be the bottle neck, limiting the use of AR to a small number of locations and simple static virtual models. Visually rich virtual content seen in music videos and science fiction movies is not the reality of AR today, because of the effort required for the production of dedicated 3-D models and their integration with physical locations.

In AR, content has traditionally been tailored for each specific point of interest, making the existing AR experiences limited to single use scenarios. As a result, AR is typically restricted to only a handful of points of interests. AR is commonly used for adding virtual objects and annotations to a view of the physical world, focusing on the informative aspects of such virtually rendered elements. However, in addition to displaying purely informative elements, AR could be used to output abstract content with a goal of enhancing a mood and atmosphere of a space and context a user is in.

Humans as a species are tuned towards escapism, which is evident by the amount of entertainment that is both produced and consumed, as well as the levels of recreational use of substances that alter our perception. With clever and novel use of existing AR technology, a digital substitution for the traditional means of altering our view of the world can be developed.

### SUMMARY

At least one exemplary method includes receiving video data from an image sensor of a mobile device, receiving audio data from an audio input module, determining a sonic characteristic of the received audio data, identifying a two-dimensional (2-D) geometric feature depicted in the received video data, and generating a virtual 3-D geometric element by extrapolating the two-dimensional geometric feature into three dimensions. The method also includes modulating the generated virtual geometric element in synchrony with the sonic characteristic and displaying the modulated virtual geometric element on a video output of the mobile device. The modulated virtual geometric element may be displayed as an overlay on the two-dimensional geometric feature. In at least one embodiment the method is executed in real-time.

The generation of the virtual 3-D geometric element by extrapolating the 2-D geometric feature into three dimensions is, in some embodiments, based at least in part on at least one of (i) a color of the identified 2-D geometric feature, (ii) a luminance of the identified 2-D geometric feature, (iii) a texture of the identified 2-D geometric feature, (iv) a position of the identified 2-D geometric feature, and (v) a size of the identified 2-D geometric feature.

Another exemplary method includes receiving video data from a camera of an AR device, receiving an audio input, identifying a 2-D geometric feature depicted in the video data, generating a virtual 3-D geometric element by extrapolating the 2-D geometric feature into three dimensions, and modulating the generated virtual geometric element based on the audio input. The method also includes, on a display of the AR device, displaying the virtual 3-D geometric element as an overlay on the 2-D geometric feature.

Another exemplary method includes receiving video data via a video input module, receiving audio data via an audio input module, identifying sonic characteristics of the received audio data, identifying visual features of the received video data, and generating virtual visual elements based at least in part on the identified visual features. The method also includes modulating the generated virtual visual elements based at least in part on the identified sonic characteristics and outputting the modulated virtual visual elements to a video output module.

At least one embodiment takes the form of an AR system. The AR system includes an image sensor, an audio input module, a display, a processor, and a non-transitory data storage medium containing instructions executable by the processor for causing the AR system to carry out one or more of the functions described herein.

In exemplary embodiments, the mobile device is an AR headset, a virtual reality (VR) headset, a smartphone, a tablet, or a laptop, among other devices. The audio input module is a media player module, a microphone, or other audio input device or system.

In at least one embodiment the audio input module includes both a media player module (e.g., the media storage 408) and a microphone (e.g., the microphone 410). In such an embodiment, the received audio data includes audio data received via the media player module and audio data received via the microphone. Identifying a sonic characteristic of the received audio data may include independently identifying a first sonic characteristic of the audio data received via the media player module and independently identifying a second sonic characteristic of the audio data received via the microphone. Furthermore, modulating the generated virtual geometric element in synchrony with the sonic characteristics may include (i) modulating the generated virtual geometric element based at least in part on the first identified sonic characteristic in a first manner, and (ii) modulating the generated virtual geometric element based at least in part on the second identified sonic characteristic in a second manner. The first and second manners may be the same, or they may be different.

In exemplary embodiments, the sonic characteristic is a tempo, a beat, a rhythm, a musical key, a genre, an amplitude peak, a frequency amplitude peak, or other characteristic. In at least one embodiment the sonic characteristic is a combination of at least two of any of the above sonic characteristics.

The identified geometric element in some embodiments is a geometric primitive, for example a shape such as a line segment, a curve, a circle, a triangle, a square, or a rectangle. Other geometric primitives include polygons, skewed versions of the above (such as an oval, a parallelogram, and a rhombus), an abstract contour, and other geometric primitives.

In some embodiments, the process of extrapolating the 2-D geometric feature into three dimensions includes performing a lathe operation on the 2-D geometric feature and/or performing an extrude operation on the 2-D geometric feature.

In at least one embodiment the generated virtual geometric element is bound, on one end, to the associated geometric element.

Exemplary modulation of the generated virtual geometric element includes modulation of the size and/or color of the generated virtual geometric element. The modulation may be synchronized with the audio data based at least in part on the identified sonic characteristics. Modulating the generated virtual geometric element may include employing an iterated function and/or a fractal approach to evolve the generated virtual geometric element.

Exemplary video output modules include an optically transparent display, a display of an AR device (such as an AR headset), and a display of a VR device (such as a VR headset).

In at least one embodiment, the modulated virtual geometric elements are overlaid on top of the received video data to create a combined video. In such an embodiment, displaying the modulated virtual geometric elements comprises displaying the combined video. The virtual geometric elements may be aligned with a real-world coordinate system.

In at least one embodiment, the virtual geometry creation is done during run-time. According to temporal rules set for the execution, basic virtual geometry building blocks are created from the analyzed visual input. With timing set by a control signal, basic building blocks are embedded within the user's view and the basic building blocks will start to grow more complex by adding iterated function system (IFS) iterations according to temporal rules set by the control signal. Once the structure created by IFS reaches certain complexity level, parts of it may start to disappear, again according to timing set by the control signal. In addition to dynamic temporal growing and dying of IFS structures, the elements are animated by adding dynamic animation transformations to the elements. The animation motion is controlled by the control signal in order to synchronize the motion with the audio or any other signals which are used as synchronization input.

In some embodiments, the user can record and share the virtual experiences that are created. For recording and sharing, a user interface is provided for the user, with which he or she can select what level of experience is being recorded and through which channels and with whom it is shared. It is possible to record just the settings (e.g., image post processing effects and geometry creation rules employed at the moment) for at least the reason that people with whom the experience is shared with can have the same interactive experience using the same audio or other songs they select. For sharing the complete experience with all the events and the environment of the user, the whole experience can be rendered as a video, where audio and virtual elements, as well as post processing effects, are all composed to a single video clip, which then can be shared via existing social media channels.

In at least one embodiment, a content-control-event creation involves using various analysis techniques to generate controls for the creation and animation of the automatically created content. Content-control-event creation can utilize at least one or more of the signal processing techniques described herein, user behavior and context information. Sensors associated with the device can include inertial measuring units (e.g., gyroscope, accelerometer, compass), eye tracking sensors, depth sensors, and various other forms of measurement devices. Events from these device sensors can be used directly to impact the control of content, and sensor data can be analyzed to get deeper understanding of the user's behavior. Context information, such as event information (e.g., at a music concert) and location information (e.g., on the golden gate bridge), can be used for tuning the style of the virtual content, when such context information is available.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 depicts an example scenario, in accordance with at least one embodiment.

FIG. 2 depicts three AR views, in accordance with at least one embodiment.

FIG. 3 depicts an example process, in accordance with at least one embodiment.

FIG. 4 depicts an example content generation system, in accordance with at least one embodiment.

FIG. 5 depicts a user wearing a VR headset, in accordance with at least one embodiment.

FIG. 6 depicts an example wireless transmit receive unit (WTRU), in accordance with at least one embodiment.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The system and process disclosed herein provides a means for automatic visual content creation, where in the visual content is typically an AR element or a VR element. In at least one embodiment, the approach includes altering the visual appearance of a physical environment surrounding a user by automatically generating visual content. The content can be used by an AR/VR system in order to create a novel experience, a digital trip, which can be synchronized with audio the user is listening to and/or sensor data captured by various sensors, and can be pre-programmed to follow specific events in an environment and context the user is in. In at least one embodiment the content creation is synchronized with the user's sound-scape, enabling creation of novel digital experiences which focus on enhancing a mood of a present situation. In this disclosure, a method which creates an AR/VR experience by automatically generating content for any location is described. The automatically created content behavior is synchronized with the sound-scape and context the user is in, thus creating novel AR/VR experience with relevant content for any location and context.

A first example takes the form of a process carried out by head-mounted transparent display system. The head-mounted transparent display system includes a processor, memory and is associated with at least one image sensor. The process includes a user selecting at least one synchronization input. The synchronization input may be a selected song or ambient noise data detected by a microphone. The synchronization input may include other sensor data as well. The image sensor provides input images for virtual geometry creation. The audio signal selected for synchronization is analyzed to gather characteristic audio data such as a beat and a rhythm. According to the beat and rhythm, virtual geometry is overlaid on visual features detected in the input images and modulated (i.e., simple elements start to change appearance and/or grow into complex virtual geometry structures). The virtual geometry is animated to move in sync with the detected audio beat and rhythm. Distinctive peaks in the audio cause visible events in the virtual geometry. In some embodiments, image post processing is used in synchronization with the audio rhythm to alter the visual outlook of the output frames. This can be done by changing a color balance of the images and 3-D rendered virtual elements, adding one or more effects such as bloom and noise to the virtual parts, and color bleed to the camera image.

Automatic content creation may be performed by creating virtual geometry from the visual information captured by a device camera or similar sensor and by post-processing images to be output to a device display. Virtual geometry is created by forming complex geometric structures from geometric primitives. Geometric primitives are basic shapes and contour segments detected by the camera or sensor (e.g., depth images from a depth sensor). The virtual geometry generation process includes building complex geometric structures from simple primitives.

Another example takes the form of a device with a sensor that provides depth information in addition to a camera that provides 2-D video frames. Such a device set-up in some embodiments is a smart glasses system with an embedded depth camera. Such a device is configured to carry out a process. The process, when utilizing the depth data, can modulate a more complete picture of the environment in which the device is running. With the aid of depth information, some embodiments operate to capture more complex pieces of 2-D or 3-D geometry from the scene and use them to create increasingly complex virtual geometric elements. For example, using the depth information, the process can operate to segment out elements in specific scale, and the system can use the segmented elements directly as basic building blocks in the virtual geometric element creation. With this approach the process is able to, for example, segment out coffee mugs on the table and start procedurally creating random organic tree like structures built from a number of similar virtual coffee mugs.

Furthermore, having comprehensive depth information available will improve 3-D tracking of the camera movements and enable more seamless integration of virtual elements to the camera image. For example, occlusions and shadows caused by the physical elements can be accounted for. Relations between virtual and physical elements are more accurately detected due to depth information. Resultantly, aligning the virtual geometry with the real-world coordinate system is improved.

Those will knowledge and skill in the relevant art are aware of methods for constructing virtual representations of a 3-D space from a set of 2-D images. This technique is generally known as 3-D reconstruction. However, regarding the description herein, full 3-D reconstruction or identical representation of the created 3-D virtual space is not required.

Before proceeding with this detailed description, it is noted that the entities, connections, arrangements, and the like that are depicted in—and described in connection with—the various figures are presented by way of example and not by way of limitation. As such, any and all statements or other indications as to what a particular figure “depicts,” what a particular element or entity in a particular figure “is” or “has,” and any and all similar statements—that may in isolation and out of context be read as absolute and therefore limiting—can only properly be read as being constructively preceded by a clause such as “In at least one embodiment, . . . ” And it is for reasons akin to brevity and clarity of presentation that this implied leading clause is not repeated ad nauseum in this detailed description.

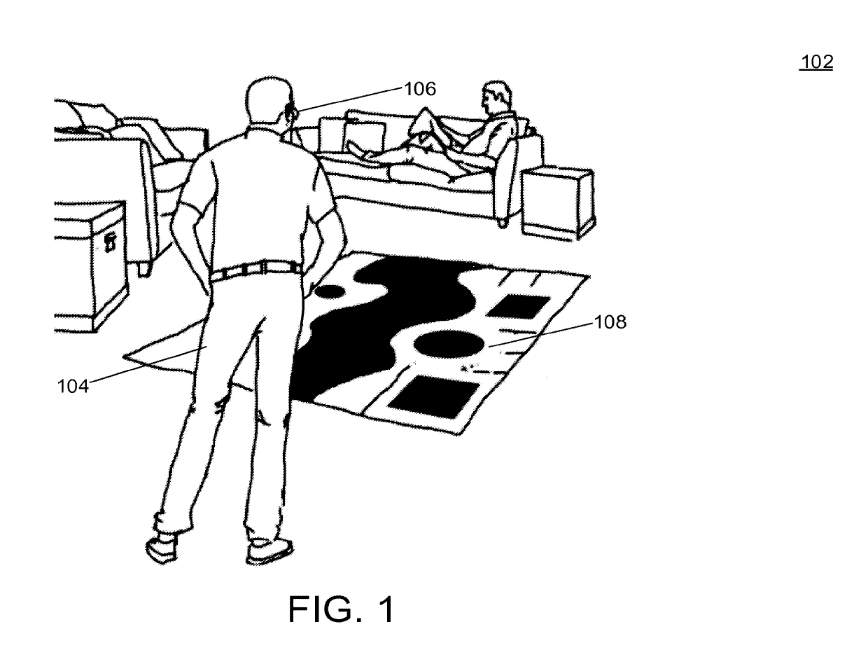

FIG. 1 depicts an example scenario, in accordance with at least one embodiment. In particular, FIG. 1 depicts a room 102 that includes a user 104 wearing a pair of video see-through AR glasses 106. The user 104 is looking through the AR glasses 106 at a rug 108. The rug 108 includes patterns which may be detected as geometric primitives by the systems and processes disclosed herein. In at least one embodiment, the user 104 inspects the room 102 while wearing the pair of video see-through AR glasses 106 and while listening to music. The user 104 selects a song to play. In some embodiments, the song is played on a mobile device attached to the AR glasses 106. As the song is playing, the user 104 is looking at the rug 108 on the floor which includes colorful patterns and shapes. Virtual geometry is generated, modulated and displayed via the AR glasses 106, which depict the colorful patterns and shapes as changing in size, position, or shape in synchrony with the song.

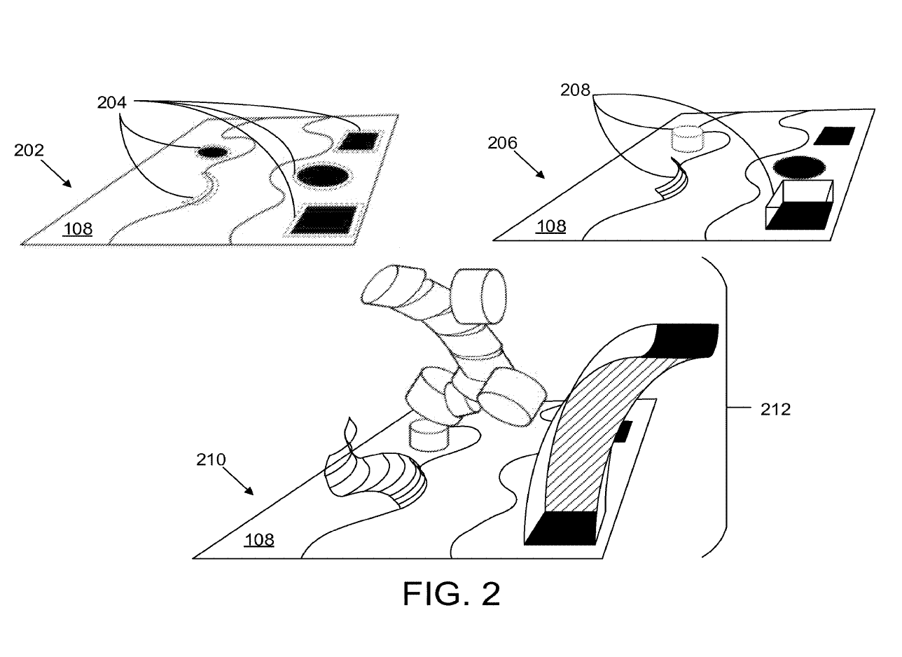

FIG. 2 depicts three AR views, in accordance with at least one embodiment. In particular, FIG. 2 depicts an AR view 202, an AR view 206, and an AR view 210. Each AR view 202, 206, and 210 depicts the rug 108 of FIG. 1 as displayed by the AR glasses 104 of FIG. 1 at different points in time.

In the AR view 202, geometric features 204, captured by a camera of the AR glasses 104, are identified. Identifying geometric features of image data is a process that is well known by those with skill in the art. Many different techniques may be employed to carry out such a task, for example Sobel filters may be used for edge detection and therefore contour identification. Other techniques for geometric feature detection, such as Hough transforms, are used in some embodiments.

In the AR view 206, virtual geometric elements 208 are generated by extrapolating the identified geometric features 204. At first, distinct shapes visible on the rug 108 emerge out of the rug 108 as 3-D shapes. Detected contour segments are extruded out of the rug 108.

In the AR view 210, the virtual geometric elements 208 are modulated in synchrony with selected audio data. As the music plays, emerging shapes sway, become interconnected and start to grow new geometry branches which are increasingly complex combinations of the first emerging shapes. The virtual geometry grows more and more complex, filling the view with psychedelic fractal shapes, and at the same time the colors of the view shift as well. The image becomes vibrant, complex and parts of the image that are brightly lit, start to glow and sparkle.

An exemplary process involves capturing audio-visual data from a device, to be used as input information for analysis and as a basis for the automatic content creation. Data gathered via a microphone and music that a user is listening to can be used as input audio signals. The captured audio is analyzed and various audio characteristics are detected. These various characteristics can be used to modulate and synchronize the output of visual effects. Also, other sensor data, such as the activity detected by sensors on the device, may be usable input for synchronizing the output of visual effects. In addition to sensor data, information about the user can be used to further personalize the created experience. Personalization can be based on the user's preferred visualization styles, preferred music styles, as well as explicit user selections. For user selections, a user interface would be employed as is known by those with skill in the relevant art. For example, the user interface can be used for controlling application modes, for selecting content types and for recording and sharing the generated content.

The virtual geometry is generated based on the geometric elements selected from the visual input. Visual input data is analyzed in order to extract distinctive shapes and contour segments. Extracted shapes and contour segments are turned into a 3-D geometry with geometric operations familiar from 3-D modelling software such as extrude and lathe, or 3-D primitive (box, sphere, etc.) matching. Generated geometry is grown and subtracted during the run-time with fractal and random procedures.

In addition to the virtual geometry augmentation, image post processing can be added to the output frames before displaying them to the user. These post processing effects can be filter effects to modify the color balance of the images, distortions added to the images and the like.

Both (i) parameters for the procedural 3-D geometry generation and (ii) parameters for image post processing, can be modified during the process run-time in synchronization with the detected audio events and audio characteristics.

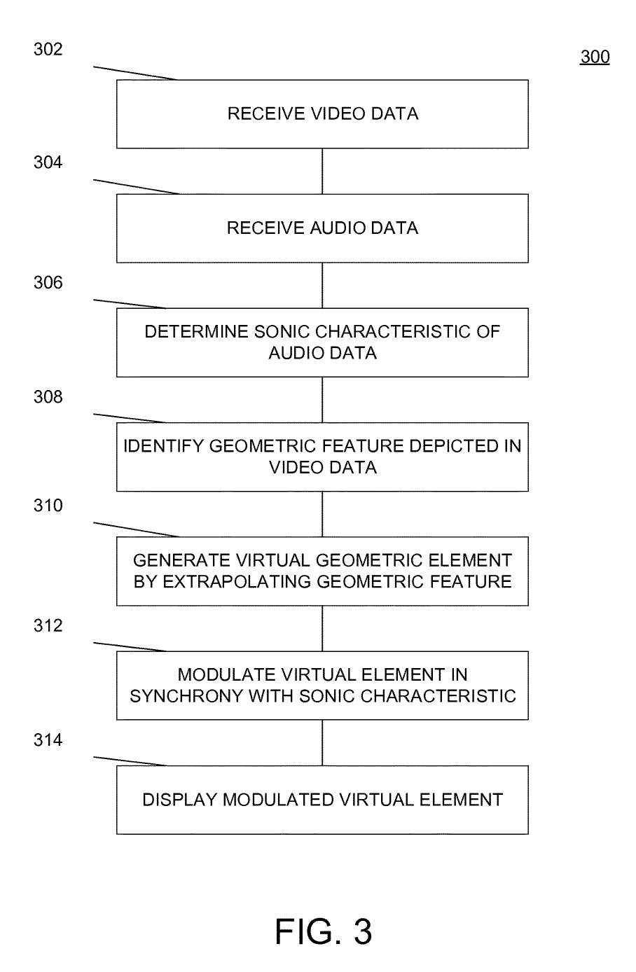

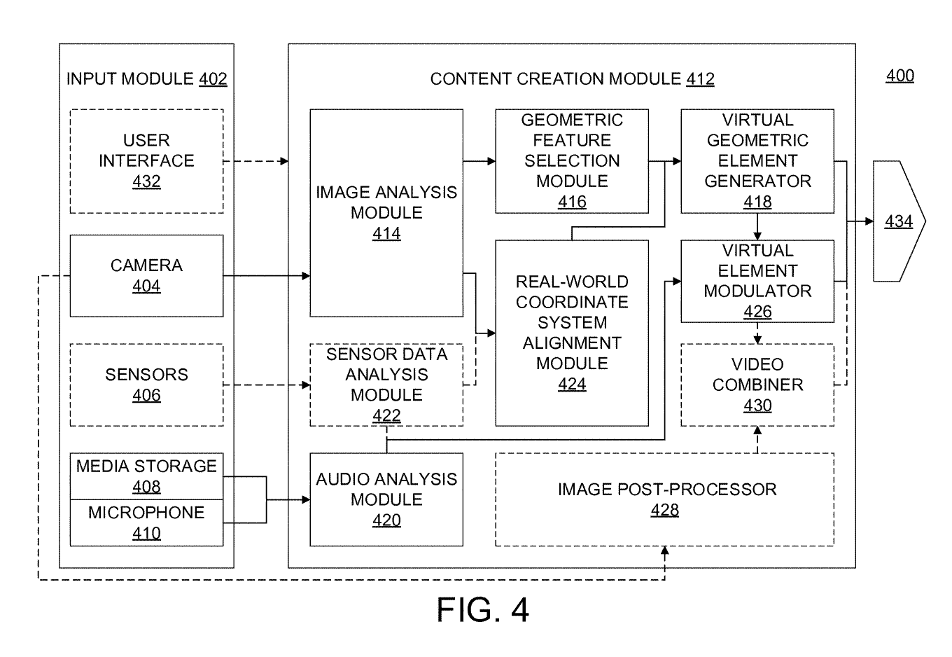

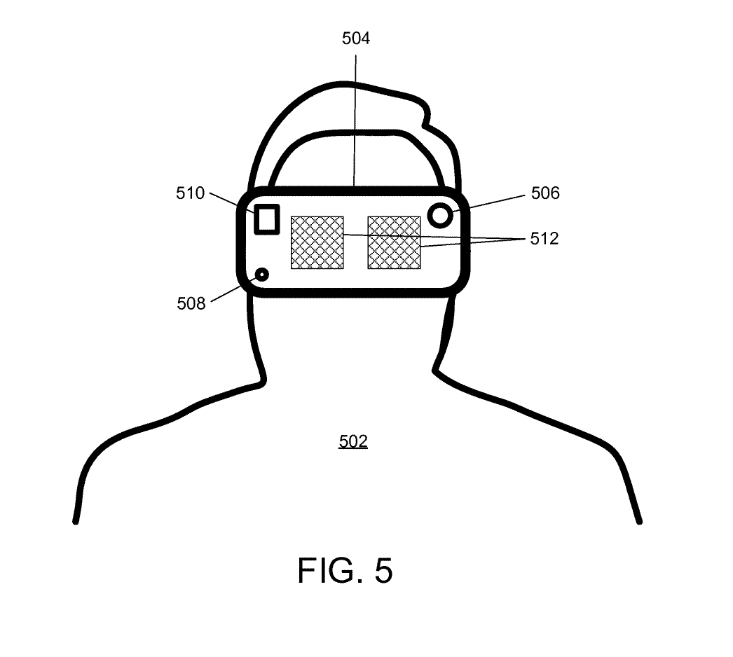

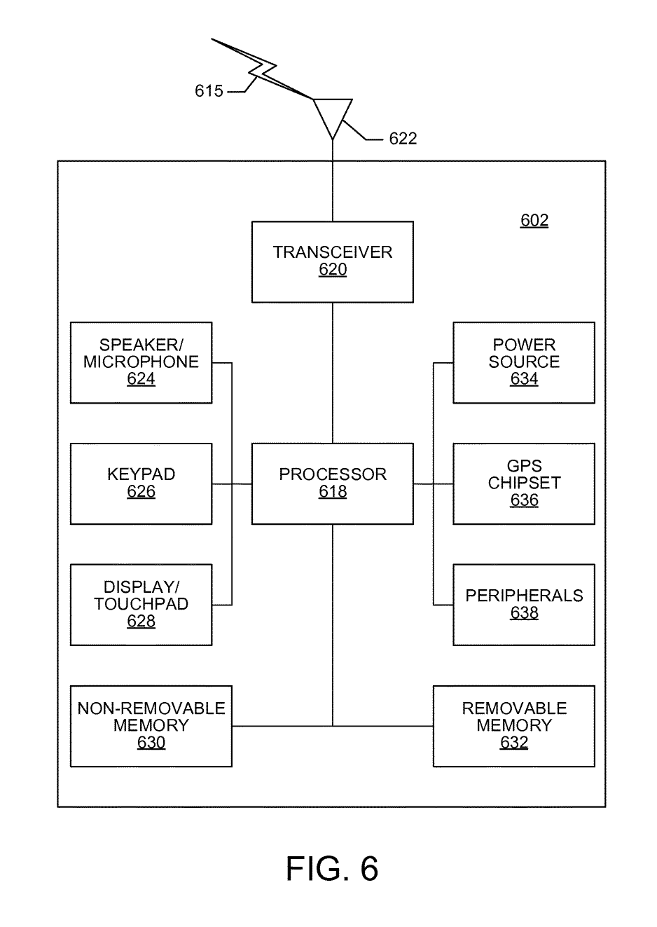

FIG. 3 depicts an example process, in accordance with at least one embodiment. In particular, FIG. 3 depicts an example process 300 that includes steps 302-314. The process 300 may be carried out by any of the systems and devices described herein such as the example content generation system 400 of FIG. 4. Furthermore, the process 300 may be carried out by a mobile device such as the WTRU 602 of FIG. 6 or a VR headset as described in connection with FIG. 5. In at least one embodiment the mobile device is an AR headset.

At step 302 the process 300 includes receiving video data from an image sensor of a mobile device. The image sensor may be a standard camera sensor, a standard camera sensor combined with a depth sensor (such as an infrared emitter and receiver) which is a form of a 3-D camera, a light-field sensor which is a form of a 3-D camera, a stereo image sensor system which is a form of a 3-D camera, and other image sensors could alternatively be used. The process 300 may further include receiving depth information from the 3-D camera of the mobile device. In such an embodiment, 2-D to 3-D reconstruction is improved and in turn so is 3-D tracking of the mobile device.

At step 304 the process 300 includes receiving audio data from an audio input module. In at least one embodiment, the audio input module is selected from the group consisting of a media player module and a microphone.

At step 306 the process 300 includes determining a sonic characteristic of the received audio data. In at least one embodiment, the sonic characteristic is a characteristic selected from the group consisting of a tempo, a beat, a rhythm, an amplitude peak, and a frequency amplitude peak.

At step 308 the process 300 includes identifying a 2-D geometric feature depicted in the received video data. In at least one embodiment, the identified geometric feature is a geometric primitive. The geometric primitive may be a shape selected from the group consisting of a line segment, a curve, a circle, a triangle, a square, and a rectangle, among other geometric primitives.

At step 310 the process 300 includes generating a virtual 3-D geometric element by extrapolating the 2-D geometric feature into three dimensions. In at least one embodiment, extrapolating the 2-D geometric feature into three dimensions includes performing a lathe operation on the 2-D geometric feature. In at least one embodiment, extrapolating the 2-D geometric feature into three dimensions includes performing an extrude operation on the 2-D geometric feature. In many embodiments, the generated virtual geometric element is bound, on one end, to the associated geometric feature.

At step 312 the process 300 includes modulating the generated virtual geometric element in synchrony with the sonic characteristic. Modulation of the generated virtual geometric element in synchrony with the sonic characteristic includes one or more of the following types of modulation: employing an iterated function system to evolve the generated virtual geometric element, employing a fractal approach to evolve the generated virtual geometric element, modulating a size of the generated virtual geometric element, modulating a color of the generated virtual geometric element, modulating a rotation of the generated virtual geometric element, modulating a texture of the generated virtual geometric element, modulating a tilt of the generated virtual geometric element, modulating an opacity of the generated virtual geometric element, modulating a brightness of the generated virtual geometric element, and/or synchronizing the modulation with the audio data based at least in part on the identified sonic characteristic.

In an exemplary embodiment, the modulated virtual geometric element is displayed as an overlay on the 2-D geometric feature. The process 300 may include overlaying the modulated virtual geometric elements on top of the received video data to create a combined video. In such an embodiment displaying the modulated virtual geometric elements to the video output module comprises displaying the combined video.

At step 314 the process 300 includes displaying the modulated virtual geometric element on a video output of the mobile device. The video output may be an optically-transparent display or a non-optically-transparent display.

Furthermore, the process 300 may be executed in real time.

FIG. 4 depicts an example content generation system, in accordance with at least one embodiment. In particular, FIG. 4 depicts an example content generation system 400 which includes an input module 402, a content creation module 412, and an output 434. It is explicitly noted that although specific connections are shown between various elements of the example content generation system 400, other connections between elements may exist when appropriate.

The input module 402 includes an optional user interface 432, a camera 404, optional sensors 406, media storage 408, and a microphone 410. The content creation module 412 includes an image analysis module 414, a geometric feature selection module 416, a virtual geometric element generator 418, an audio analysis module 420, an optional sensor data analysis module 422, a real-world coordinate system alignment module 424, a virtual element modulator 426, an optional image post-processor 428, and an optional video combiner 430. The example content generation system 400 further includes the output 434.

The optional user interface 432 provides a means for user input. The user interface 432 may take the form of one or more, buttons, switches, sliders, touchscreens, or the like. Furthermore, the user interface 432 may communicate with the camera 404 to provide a means for visual-gesture-based input (e.g., pointing at an identified geometric feature as a means for geometric feature selection) and/or the microphone 410 to provide a means for audible-gesture-based input (e.g., voice activated “on”/“off” commands) and/or the sensors 406 to provide a means for sensor-gesture-based input (e.g., accelerometer/motion-activated image post-processing settings manipulation). In general, the user interface 432 provides a means for adjusting content creation parameters which in turn control the execution of the content creation module 412. The user interface 432 is coupled to the content creation module 412.

Content creation parameters may be previously stored in a data storage of the example content generation system 400. In such an embodiment the user interface 432 is not necessary. A non-limiting set of example content creation parameters is provided below. Content creation parameters are sent from the input module 402 to the content creation module 412.

Content creation parameters may include an audio input selection. The audio input selection determines which source (e.g., the media storage 408, the microphone 410, or both) is to be used as a provider of audio data to the audio analysis module 420.

Content creation parameters may include a media selection. The media selection determines which file in the media storage 408 is to be used by the audio analysis module 420.

Content creation parameters may include geometric feature identification settings. Geometric feature identification settings determine how the image analysis module 414 is to operate when identifying geometric features of the video data. Various parameters may include the operational settings of edge detection filters, shape-matching tolerances, and a maximum number of geometric elements to identify, among other parameters.

Content creation parameters may include geometric feature selection settings. Geometric feature selection settings determine how and which identified geometric features are selected by the geometric feature selection module 416 for use by the virtual geometric element generator 418. In some examples, a user provides input via the user interface 432 to select which of the identified geometric features are to be passed along to the virtual geometric element generator 418. In some examples, hard-coded geometric feature selection settings determine which of the identified geometric features are to be passed along to the virtual geometric element generator 418. For example, a hard-coded setting may dictate that the five largest identified geometric features are to be passed along to the virtual geometric element generator 418. A user provided input may take the form of a voice command indicating that all identified squares are to be passed along to the virtual geometric element generator 418.

Content creation parameters may include virtual geometric element generation settings. Geometric element generation settings control how identified geometric features are extrapolated into virtual geometric elements by the virtual geometric element generator 418. An example geometric element generation setting dictates that identified rectangles are to be extrapolated into rectangular prisms of a certain height. Another example geometric element generation setting dictates that identified ovals are to be extrapolated into 3-D ellipses of a certain color. Yet another example geometric element generation setting dictates that identified contours are to be extrapolated into surfaces having a given texture.

Content creation parameters may include audio-analysis-based modulation settings. Audio-analysis-based modulation settings dictate how a given virtual geometric element is modulated in response to a certain sonic characteristic. These settings are used by the virtual element modulator 426. An example audio-analysis-based modulation setting may dictate a proportion by which a volume of a virtual geometric element is to expand or contract in response to a detected audio signal amplitude. Another example audio-analysis-based modulation setting may dictate an angle and an angular rate around which a virtual geometric element will rotate in response to a detected tempo. Yet another example audio-analysis-based modulation setting dictates a function describing how a virtual geometric element is to change colors in response to detected frequency information (i.e., a relationship between the amplitudes of detected frequencies and the color of the virtual element). Furthermore, audio-analysis-based modulation settings may dictate how a virtual geometric element is to evolve into a more complex visual structure through the concatenation of similarly shaped virtual objects.

Content creation parameters may include sensor-data-analysis-based modulation settings. These settings are used by the virtual element modulator 426. An example sensor-data-analysis-based modulation setting dictates how a virtual geometric element will tilt in response to a detected accelerometer signal amplitude. Another example sensor-data-analysis-based modulation setting dictates how a texture of a virtual geometric element will change in response to digital thermometer data. Yet another example sensor-data-analysis-based modulation setting dictates a function describing how sharp or rounded the corners of a virtual geometric element will be in response to detected digital compass information (e.g., a relationship between the direction the system 400 is oriented and the roundedness of the corners of the virtual element). Furthermore, sensor-data-analysis-based modulation settings may dictate how a virtual geometric element is to evolve into a more complex visual structure through the concatenation of similarly shaped virtual objects.

Content creation parameters may include image post-processing settings. Image post-processing settings may determine a color of a filter that acts on the video data. Image post-processing settings may determine a strength of a glow effect that operates on the video data.

Other content creations settings may indicate whether or not post-processed video is combined with the output of the virtual element modulator 428 at the video combiner 430. In some embodiments, post-processed video is combined with the output of the virtual element modulator 428 at the video combiner 430 and the output 434 receives the combined video. In some embodiments, post-processed video is not combined with the output of the virtual element modulator 428 at the video combiner 430 and the output 434 receives uncombined content generated by the virtual element modulator 428.

The camera 404 may include one or more image sensors, depth sensors, light-field sensors, and the like, or any combination thereof. The camera 404 is coupled to the image analysis module 414 and may be coupled to the image post-processor 428 as well. The camera 404 captures video data and the captured video data is sent to the image analysis module 414 and optionally to the image post-processor 428. The captured video data may include depth information.

The optional sensors 406 may include one or more of a global positioning system (GPS), a compass, a magnetometer, a gyroscope, an accelerometer, a barometer, a thermometer, a piezoelectric sensor, an electrode (e.g., of an electroencephalogram), a heart-rate monitor, or any combination thereof. The sensors 406 are coupled to the sensor data analysis module 422. If present and enabled, the sensors 406 capture sensor data and the captured sensor data is sent to the sensor data analysis module 422.

The media storage 408 may include a hard drive disc, a solid state disc, or the like and is coupled to the audio analysis module 420. The media storage 408 provides the audio analysis module 420 with a selected audio file. The microphone 410 may include one or more microphones or microphone arrays and is coupled to the audio analysis module 420. The microphone 410 captures ambient sound data and the captured ambient sound data is sent to the audio analysis module 420. In some embodiments the media storage 408 is present and included in the input module 402 and the microphone 410 is not present nor included in the input module 402. In some embodiments the media storage 408 is not present nor included in the input module 402 and the microphone 410 is present and included in the input module 402. In some embodiments both the media storage 408 and the microphone 410 are present and included in the input module 402.

Each element or module in the content creation module 412 may be implemented as a hardware element or as a software element executed by a processor or as a combination of the two.

The image analysis module 414 receives video data from the camera 404. The exemplary image analysis module 414 serves at least two purposes.

Firstly, the image analysis module 414 identifies geometric features (such as geometric primitives) depicted in the received video data. Data processing for detecting geometric primitives and contour segments can be achieved with well-known image processing algorithms. For example, OpenCV features a powerful selection of image processing algorithms with optimized implementations for several platforms. It is often the tool of choice for many programmable image processing tasks. Image processing algorithms may be used to process depth information as well. Depth information is often represented as an image in which pixel values represent depth values.

Secondly, the image analysis module 414 implements 3-D tracking. The image analysis module may analyze the camera data (and, if available, the depth data) in order to determine a real-time position and orientation of the AR/VR device. Such an analysis may involve a 2-D to 3-D spatial reconstruction step. The 3-D tracking allows the real-world coordinate system alignment module 424 to determine where virtual geometric elements are displayed on an output video feed.

The image analysis module 414 may perform a perspective shift on the incoming image and depth data. In one use, the perspective shift allows for the spatial synchronization of the received image data and depth data, where the perspective shift modifies either the image data, the sensor data, or both so that the data appears as if it was captured by sensors in the same position. This improves image analysis.

In a second use, the perspective shift allows for more extreme virtual perspectives to be used by the image analysis module 414. This may be useful for identifying geometric features which are skewed due to a particular perspective of the system. For example, in, FIG. 1 the user 104 is looking at the rug 108. It is possible that one of the patterns on the rug 108 is a perfect circle. When viewed at an angle (when captured by the camera 404 at an angle) the circle will appear to be an oval. A perspective shift can enable the image analysis module 414 to reconstruct the view of the rug 108 so that the circle is identified as a circle and not as an oval.

The operation of the image analysis module 414 is carried out in accordance with the content creation settings.

The geometric feature selection module 416 receives the relevant output of the image analysis module 414. The geometric feature selection module 416 determines which of the identified geometric features are to be used for content generation. The determination may be made according to user input and/or according to hard-coded instructions. The operation of the geometric feature selection module 416 is carried out in accordance with the content creation settings.

The virtual geometric element generator 418 receives the output of geometric feature selection module 416 (e.g., a set of selected geometric features) as well as alignment information from the real-world coordinate system alignment module 424.

In at least one embodiment, virtual geometry is generated with procedural methods and is based, at least in part, selected visual elements as indicated by the geometric feature selection module 416. In at least one embodiment, the method identifies (at the image analysis module 414) clear contours, contour segments, well defined geometric primitives, such as circles, rectangles etc. and uses the selected elements to generate virtual 3-D geometry. Individual contour segments can be extrapolated into 3-D geometry with operations such as lathe and extrude, and detected basic geometry primitives can be extrapolated from 2-D to 3-D, e.g. an identified square shape is extrapolated into a virtual box and circle to a sphere or cylinder. In some embodiments, wherein a depth sensor is employed, reconstructing environment geometry can be replaced with a shape filling algorithm using other 3-D objects. The sensed geometry can be warped and transformed.

The virtual geometric element generator 418 receives the output of the real-world coordinate system alignment module 424 in order to determine where virtual geometric elements (generated by the virtual geometric element generator 418) are displayed on the output video feed.

The operation of the virtual geometric element generator 418 is carried out in accordance with the content creation settings.

The audio analysis module 420 receives audio data from the audio input module. The audio input module includes either of both of the media storage 408 and the microphone 410.

Media players such as Apple's iTunes and Microsoft's Windows Media Player come with plug-ins for detecting some basic sonic characteristics of an audio signal, which are used for creating visual effects accordingly. The simple analysis used for these visualizations is based on detecting amplitude peaks, frequency data and musical beats. Beat detection is a well-established area of research, with a plurality of algorithms and software tools available for the task. For example, at least one beat spectrum algorithm is a potential approach for detection of basic beat characteristics from the audio signal.

Music videos and audio visualizations provided by media player applications are traditional cases wherein visual content is synchronized to distinctive features observed in an audio signal. In the case of automatic synchronization, audio analysis algorithms can be used by systems of the present disclosure to detect distinctive features from the audio signal (e.g., various frequency information retrieved from Fourier analysis), which in turn can be used to control the presentation of visual content with the goal of synchronizing an audiovisual experience. Detection of audio features can be achieved with known methods, as described for example in Lu, L., Liu, D., & Zhang, H. J., “Automatic mood detection and tracking of music audio signals”, IEEE Transactions on audio, speech, and language processing, 14(1), 5-18, 2006. Similarly, other data (other than audio data/e.g., gyroscopic data, compass data, GPS data, barometer data, etc.) can be analyzed to broaden synchronization/modulation inputs.

In addition to simple beat detection, algorithmic methods can be used for detecting more complex characteristics from music, for example, music information retrieval (e.g. genre classification of music pieces). In addition to music information retrieval, generic detection of a mood conveyed by the music can be performed. In at least one embodiment, information from a mood analysis tool or a music classification technique is used to help control the creation and animation of the automatically created content. Tools for extracting large number of detailed features from audio include libXtract, YAAFE, openSmile, and many other tools known to those with skill in the relevant art.

In at least one embodiment, a synchronization input analysis is used for detecting characteristics from the audio input signal which can be used to control the creation and animation of the automatically created content. Audio analysis may be used to detect characteristics from the input stream, such as tempo, sonic peaks and rhythm. Detected characteristics are used to help control the creation and animation of the procedurally created content. This creates a connection between external events and virtual content. Input signals to be analyzed may be music selected by the user or ambient sounds captured by a microphone.

The operation of the audio analysis module 420 is carried out in accordance with the content creation settings.

The optional sensor-data analysis module 422 receives sensor data from the option sensors 406.

In at least one embodiment, a synchronization input analysis is used for detecting characteristics from the sensor data which can be used to control the creation and animation of the automatically created content. Sensor data analysis may be used to detect characteristics from the input stream, such as dominant frequencies, amplitude peaks and the like. Detected characteristics are used to help control the creation and animation of the procedurally created content. This creates a connection between external events and virtual content. In some embodiments, signals, such as motion sensor data, are used for contributing to the creation and animation of the automatically created content. In some embodiments, appropriate signal analysis for various different types of signals is needed. In addition to the real-time analysis for helping to control the creation and animation of the automatically created content, it is possible to use pre-defined control sequences, which can be synchronized with some expected events, such as stage events in a theatre or a concert.

Additionally, analyzed sensor data may be used in conjunction with analyzed image data in order to provide a means for 3-D-motion tracking.

The operation of the sensor data analysis module 422 is carried out in accordance with the content creation settings.

The real-world coordinate system alignment module 424 receives the output of the image analysis module 414 as well as the output of the optional sensor-data analysis module 422.

In at least one embodiment, the generated virtual 3-D geometry is aligned with a real world coordinate system based on viewpoint location data and orientation data calculated by the 3-D tracking step. Viewpoint location and orientation updates are provided by the 3-D tracking which enables virtual content to maintain location match with the physical world. 3-D tracking is used for maintaining the relative camera/sensor position and orientation relative to the sensed environment. With the sensor orientation and position resolved by a tracking algorithm, the content to be displayed can be aligned in a common coordinate system with the physical world. As result, 3-D geometry maintains orientation and location registration with the real world as the user moves, creating an illusion of generated virtual geometry being attached to the environment. 3-D tracking can be achieved by many known methods, such as SLAM and any other sufficient approach.

The virtual element modulator 426 receives the output of the virtual geometric element generator 418, the optional sensor-data analysis module 422, as well as the audio analysis module 420.

The virtual geometry may be evolved (e.g. modulated) with a fractal approach. Fractals are iterative mathematical structures, which when plotted to 2-D or 3-D images, produce infinite level of varying details. A famous example of fractal geometry is the bug-like figure of classic Mandelbrot set, named after Benoit Mandelbrot, developer of the field of fractal geometry. A Mandelbrot series is a set of complex numbers sampled under iteration of a complex quadratic polynomial. As complex numbers are inherently two dimensional, mapping values to real and imaginary parts in a complex plane, this classical fractal approach is one example approach for creating 2-D visualizations. Although there are some approaches for extending classical fractal formulas to three dimensions, such as Mandelbud, there exist other approaches available for creating 3-D geometry in similar manner, which still enable the creation of complexity from simple starting conditions (e.g., audio input data and visual input data and the results of their analysis).

Some embodiments employ procedural geometry techniques such as noise, fractals and L-systems. A comprehensive overview of the procedural methods associated with 3-D geometry and computer graphics in general may be found in Ebert, D. S., ed., “Texturing & modeling: a procedural approach”. Morgan Kaufmann, 2003.

Some embodiments employ IFS. IFS is a method for creating complex structures from simple building blocks by applying a set transformations to the results of previous iterations. Modulated virtual geometry achieved with this approach tends to have a repetitive self-similar and organic appearance. In at least one embodiment, an IFS is defined using (i) the detected basic shapes (e.g., geometric primitives) which are extended to 3-D elements, as well as (ii) simple 3-D shapes created by lathe and extrusion operations of clear image contour lines. These building blocks are iteratively combined with random or semi-random transformation rules. This is an approach which is used in commercial IFS modelling software such as XenoDream. Ultra Fractal is another fractal design software, with more emphasis on 2-D fractal generation.

The operation of the virtual element modulator 426 is carried out in accordance with the content creation settings.

The optional image post-processor 428 receives video data from the camera 404. Output images can be further post-processed in order to add further digital effects to the output. Post-processing can be used to add filter effects to alter the color balance of the whole image, alter certain color areas, adjust opacity, add blur and noise etc.

The operation of the image post-processor 428 is carried out in accordance with the content creation settings.

The video combiner 430 receives the output of the virtual element modulator 426 as well as the optional image post-processor 428. The video combiner 430 is primarily implemented in VR embodiments because the display of the device is not optically transparent. However, the video combiner 430 may still be implemented and used in AR embodiments. At the video combiner 430 output images are prepared by rendering the image sensor data in the output buffer background and then rendering the virtual geometric elements on top of the background texture.

The operation of the video combiner 430 is carried out in accordance with the content creation settings.

The output 434 receives the output of the virtual geometric element generator 418, the virtual element modulator 426, as well as the optional video combiner 430. When a new virtual geometric element is generated it is sent to the output 434 for display. Modulations to a given virtual element (as determined by the virtual element modulator 426) are sent to the output 434 and the view of the given virtual element is updated accordingly. In some embodiments, the combined video depicting the modulated virtual element overlaid on top on the optionally post-processed camera image data is displayed by the output 434. In at least one embodiment, the output 434 is a display of a viewing device. The display can be, for example, a mobile device such as smart phone, a head mounted display with an optically transparent viewing area, a head mounted AR system, a VR system, or any other suitable viewing device.

Exemplary embodiments of the presently disclosed systems and processes addresses a common pitfall of AR applications available today, which is the limited content resulting in short-lived user experiences. Furthermore, these systems and processes extend the use of AR to new areas, not focusing on pure information visualization that AR has traditionally been applied to, but rather on displaying abstract content and enhancing the emotion and mood of the user's sound-scape. These systems and processes are involved with the concept of altering user's perception by means of digital technology, by providing a safe way to distort the reality the user is sensing. Compared with traditional audio visualization solutions these systems and processes create content based on a sensed reality and overlays it on the environment.

Exemplary methods described here are suitable for use with head mounted displays. One example experience employs an immersive optical see-through binocular head mounted display with opaque rendering of virtual elements or a video see-through head mounted display. However, it should be noted that the proposed method is not tightly bound with any specific display device, and it can be used already with current mobile devices.

In some embodiments, the systems and methods described herein may be implemented in a VR headset, such as a VR headset 504 of FIG. 5.

FIG. 5 depicts a user wearing a VR headset, in accordance with at least one embodiment. In particular, FIG. 5 depicts a user 502 waring a VR headset 504. The VR headset 504 includes a camera 506, a microphone 508, sensors 510, and a display 512. Other components such as a data store, a processor, a user interface, and a power source are included in the VR headset 504, but have been omitted for the sake of visual simplicity. The VR headset 504 may carry out the steps associated with the process 300 of FIG. 3 and/or implement the functionality associated with the example content generation system 400 of FIG. 4.

The camera 506 may be a 2-D camera, or a 3-D camera.

The microphone 508 may be a single microphone or a microphone array.

The sensors 510 may include one or more of a GPS, a compass, a magnetometer, a gyroscope, an accelerometer, a barometer, a thermometer, a piezoelectric sensor, an electrode (e.g., of an electroencephalogram), and a heart-rate monitor.

The display 512 is a non-optically-transparent display. As a result, a video combiner (such as the video combiner 430 of FIG. 4) is utilized so as to create a view of the present scene overlaid with the modulated virtual elements.

In some embodiments, the systems and methods described herein may be implemented in a WTRU, such as the WTRU 602 illustrated in FIG. 6. For example, an AR headset, a VR headset, a head-mounted display system, smart-glasses, and a smartphone each may be embodied as a WTRU.

As shown in FIG. 6, the WTRU 602 may include a processor 618, a transceiver 620, a transmit/receive element 622, audio transducers 624 (preferably including at least two microphones and at least two speakers, which may be earphones), a keypad 626, a display/touchpad 628, a non-removable memory 630, a removable memory 632, a power source 634, a GPS chipset 636, and other peripherals 638. It will be appreciated that the WTRU 602 may include any sub-combination of the foregoing elements while remaining consistent with an embodiment. The WTRU 602 may further include any of the sensors described above in connection with the various embodiments. The WTRU 602 may communicate with nodes such as, but not limited to, base transceiver station (BTS), a Node-B, a site controller, an access point (AP), a home node-B, an evolved home node-B (eNodeB), a home evolved node-B (HeNB), a home evolved node-B gateway, and proxy nodes, among others.

The processor 618 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 618 may perform signal coding, data processing, power control, input/output processing, and/or any other functionality that enables the WTRU 602 to carry out the functions described herein. The processor 618 may be coupled to the transceiver 620, which may be coupled to the transmit/receive element 622. While FIG. 6 depicts the processor 618 and the transceiver 620 as separate components, it will be appreciated that the processor 618 and the transceiver 620 may be integrated together in an electronic package or chip.

The transmit/receive element 622 may be configured to transmit signals to, or receive signals from, a node over the air interface 615. For example, in one embodiment, the transmit/receive element 622 may be an antenna configured to transmit and/or receive RF signals. In another embodiment, the transmit/receive element 622 may be an emitter/detector configured to transmit and/or receive IR, UV, or visible light signals, as examples. In yet another embodiment, the transmit/receive element 622 may be configured to transmit and receive both RF and light signals. It will be appreciated that the transmit/receive element 622 may be configured to transmit and/or receive any combination of wireless signals.

In addition, although the transmit/receive element 622 is depicted in FIG. 4 as a single element, the WTRU 602 may include any number of transmit/receive elements 622. More specifically, the WTRU 602 may employ MIMO technology. Thus, in one embodiment, the WTRU 602 may include two or more transmit/receive elements 622 (e.g., multiple antennas) for transmitting and receiving wireless signals over the air interface 615.

The transceiver 620 may be configured to modulate the signals that are to be transmitted by the transmit/receive element 622 and to demodulate the signals that are received by the transmit/receive element 622. As noted above, the WTRU 702 may have multi-mode capabilities. Thus, the transceiver 620 may include multiple transceivers for enabling the WTRU 602 to communicate via multiple RATs, such as UTRA and IEEE 802.11, as examples.

The processor 618 of the WTRU 602 may be coupled to, and may receive user input data from, the audio transducers 624, the keypad 626, and/or the display/touchpad 628 (e.g., a liquid crystal display (LCD) display unit, organic light-emitting diode (OLED) display unit, head-mounted display unit, or optically transparent display unit). The processor 618 may also output user data to the speaker/microphone 624, the keypad 626, and/or the display/touchpad 628. In addition, the processor 618 may access information from, and store data in, any type of suitable memory, such as the non-removable memory 630 and/or the removable memory 632. The non-removable memory 630 may include random-access memory (RAM), read-only memory (ROM), a hard disk, or any other type of memory storage device. The removable memory 632 may include a subscriber identity module (SIM) card, a memory stick, a secure digital (SD) memory card, and the like. In other embodiments, the processor 618 may access information from, and store data in, memory that is not physically located on the WTRU 602, such as on a server or a home computer (not shown).

The processor 618 may receive power from the power source 634, and may be configured to distribute and/or control the power to the other components in the WTRU 602. The power source 634 may be any suitable device for powering the WTRU 602. As examples, the power source 634 may include one or more dry cell batteries (e.g., nickel-cadmium (NiCd), nickel-zinc (NiZn), nickel metal hydride (NiMH), lithium-ion (Li-ion), and the like), solar cells, fuel cells, and the like.

The processor 618 may also be coupled to the GPS chipset 636, which may be configured to provide location information (e.g., longitude and latitude) regarding the current location of the WTRU 602. In addition to, or in lieu of, the information from the GPS chipset 636, the WTRU 602 may receive location information over the air interface 615 from a base station and/or determine its location based on the timing of the signals being received from two or more nearby base stations. It will be appreciated that the WTRU 602 may acquire location information by way of any suitable location-determination method while remaining consistent with an embodiment.

The processor 618 may further be coupled to other peripherals 638, which may include one or more software and/or hardware modules that provide additional features, functionality and/or wired or wireless connectivity. For example, the peripherals 638 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

In the present disclosure, various elements of one or more of the described embodiments are referred to as modules that carry out (i.e., perform, execute, and the like) various functions described herein. As the term “module” is used herein, each described module includes hardware (e.g., one or more processors, microprocessors, microcontrollers, microchips, application-specific integrated circuits (ASICs), field programmable gate arrays (FPGAs), memory devices, and/or one or more of any other type or types of devices and/or components deemed suitable by those of skill in the relevant art in a given context and/or for a given implementation. Each described module also includes instructions executable for carrying out the one or more functions described as being carried out by the particular module, where those instructions take the form of or at least include hardware (i.e., hardwired) instructions, firmware instructions, software instructions, and/or the like, stored in any non-transitory computer-readable medium deemed suitable by those of skill in the relevant art.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

What is claimed is:

1. A method comprising:
receiving video data from an image sensor of a mobile device;
receiving audio data from an audio input module;
determining a sonic characteristic of the received audio data;
identifying a two-dimensional (2-D) geometric feature depicted in the received video data;
generating a virtual three-dimensional (3-D) geometric element by extrapolating the 2-D geometric feature into three dimensions;
modulating the generated virtual geometric element in synchrony with the sonic characteristic; and
displaying the modulated virtual geometric element on a video output of the mobile device.

2. The method of claim 1, wherein the mobile device is an augmented reality headset.

3. The method of claim 1, wherein the audio input module is selected from the group consisting of a media player module and a microphone.

4. The method of claim 1, wherein sonic characteristic is a characteristic selected from the group consisting of a tempo, a beat, a rhythm, an amplitude peak, and a frequency amplitude peak.

5. The method of claim 1, wherein the identified geometric feature is a geometric primitive.

6. The method of claim 5, wherein the geometric primitive is a shape selected from the group consisting of a line segment, a curve, a circle, a triangle, a square, and a rectangle.

7. The method of claim 1, wherein extrapolating the 2-D geometric feature into three dimensions includes performing a lathe operation on the 2-D geometric feature.

8. The method of claim 1, wherein extrapolating the 2-D geometric feature into three dimensions includes performing an extrude operation on the 2-D geometric feature.

9. The method of claim 1, wherein the generated virtual geometric element is bound, on one end, to the associated geometric feature.

10. The method of claim 1, wherein modulating the generated virtual geometric element in synchrony with the sonic characteristic includes employing an iterated function system to evolve the generated virtual geometric element.

11. The method of claim 1, wherein modulating the generated virtual geometric element in synchrony with the sonic characteristic includes modulating a size of the generated virtual geometric element.

12. The method of claim 1, wherein modulating the generated virtual geometric element in synchrony with the sonic characteristic includes modulating a color of the generated virtual geometric element.

13. The method of claim 1, wherein modulating the generated virtual geometric elements in synchrony with the sonic characteristic comprises synchronizing the modulation with the audio data based at least in part on the identified sonic characteristics.

14. The method of claim 1, wherein the video output is an optically transparent display.

15. The method of claim 1, wherein the video output is a display of an augmented reality device.

16. The method of claim 1, further comprising:
overlaying the modulated virtual geometric elements on top of the received video data to create a combined video, and
wherein displaying the modulated virtual geometric elements to the video output module comprises displaying the combined video.

17. The method of claim 1, executed in real-time.

18. The method of claim 1, wherein the modulated virtual geometric element is displayed as an overlay on the 2-D geometric feature.

19. A method comprising:
receiving video data from a camera of an augmented reality (AR) device;
receiving an audio input;
identifying a two-dimensional (2-D) geometric feature depicted in the video data;
generating a virtual three-dimensional (3-D) geometric element by extrapolating the 2-D geometric feature into three dimensions;
modulating the generated virtual geometric element based on the audio input; and
on a display of the AR device, displaying the virtual 3-D geometric element as an overlay on the 2-D geometric feature.

20. An augmented reality system comprising:
an image sensor,
an audio input module,
a display,
a processor, and
a non-transitory data storage medium containing instructions executable by the processor for causing the system to carry out a set of functions, the set of functions including:
receiving video data from the image sensor;
receiving audio data from the audio input module;
determining a sonic characteristic of the received audio data;
identifying a two-dimensional (2-D) geometric feature depicted in the received video data;
generating a virtual three-dimensional (3-D) geometric element by extrapolating the 2-D geometric feature into three dimensions;
modulating the generated virtual 3-D geometric element based on the sonic characteristic; and
displaying the modulated virtual 3-D geometric element on the display.
